(19) United States
(12) Patent Application Publication
(10) Pub. No.: US 2014/0097728 A1
(43) Pub. Date: Apr. 10, 2014

(54) VIBRATION SUPPRESION CASING

(71) Applicants: INVENTEC (PUDONG) TECHNOLOGY CORPORATION, Shanghai (CN); INVENTEC CORPORATION, Taipei City (TW)

(72) Inventor: Tsu-Hui YANG, Taipei City (TW)

(73) Assignees: INVENTEC CORPORATION, Taipei City (TW); INVENTEC (PUDONG) TECHNOLOGY CORPORATION, Shanghai (CN)

(21) Appl. No.: 13/846,360

(22) Filed: Mar. 18, 2013

(30) Foreign Application Priority Data
Oct. 9, 2012 (CN) 201210379872.4

(51) Int. Cl. G06F 1/16

(52) U.S. Cl. CPC G06F 1/16
USPC 312/223.2

(57) ABSTRACT

A vibration suppression casing is suitable for a computing system including a chassis, a mainboard, and an electronic device. The mainboard is disposed in the chassis. The electronic device is disposed in the chassis. The computing system is adapted to generate a vibration wave while running The vibration suppression casing includes a case body and a vibration suppression unit. The case body is detachably attached to the chassis. The vibration suppression unit, disposed on the case body, includes a base, an elastic arm and a balancing weight. The base is securely disposed on the case body. The elastic arm has a first end and a second end opposite to each other. The first end is connected to the base. The balancing weight is disposed on the second end. The balancing weight moves in conjunction with the movement of the attached base, driven by the vibration wave.

### CROSS-REFERENCE TO RELATED APPLICATIONS

This non-provisional application claims priority under 35 U.S.C. §119(a) on Patent Application No(s). 201210379872.4 filed in China on Oct. 9, 2012, the entire contents of which are hereby incorporated by reference.

### BACKGROUND

1. Technical Field

The disclosure relates to a vibration suppression casing, and more particularly to a vibration suppression casing with a vibration suppression unit.

2. Related Art

In recent years, efficiencies of electronic devices in a computing system must be improved along with the progress of computer and network technology, to meet the demands of users. For example, the electronic device is a processor, so the computing speed of the processor in a computing system, the storage capacity or the running speed of a hard disk are bound to be improved, so as to meet the demands of users.

Please refer to the FIG. 1, which is a partial exploded view of a conventional computing system. In conventional technology, a computing system 10 comprises a chassis 11, an upper case body 12 and an electronic device (not shown). The upper case body 12 comprises a slider 121. The chassis 11 comprises a runner 111. The case body 12 is attached to the chassis 11 by the slider 121 sliding into the runner 111. A clearance is prone to be formed between the slider 121 and the runner 111 due to the tolerance factor in the production of the computing system 10. The electronic device is a hard disk. When the hard disk runs at high speed, vibration occurs. Therefore, when the electronic device of the computing system 10 vibrates while running, a vibration wave will be transferred to the chassis 11 and the upper case body 12 via a circuit board (not shown). Because a clearance exists between the slider 121 and the runner 111, the vibration may lead to friction between them, followed by a noise generation, resulting in discomfort to users.

### SUMMARY

An embodiment of this disclosure provides a vibration suppression casing which is suitable for a computing system including a chassis, a mainboard, and an electronic device. The mainboard is disposed in the chassis. The electronic device is disposed in the chassis. The computing system is adapted to generate a vibration wave while running The vibration suppression casing comprises a case body and a vibration suppression unit. The case body is detachably attached to the chassis. The vibration suppression unit, disposed on the case body, comprises a base, an elastic arm and a balancing weight. The base is securely disposed on the case body. The elastic arm has a first end and a second end opposite to each other. The first end is connected to the base. The balancing weight is disposed on the second end. The balancing weight moves in conjunction with the movement of the attached base, driven by the vibration wave.

### BRIEF DESCRIPTION OF THE DRAWINGS

The disclosure will become more fully understood from the detailed description given herein below for illustration only, and thus are not limitative of the disclosure, and wherein:

FIG. 1 is a partial exploded view of a conventional computing system;

FIG. 2 is a schematic view of a computing system according to a first embodiment;

FIG. 3 is a partial schematic view of a vibration suppression casing according to the first embodiment;

FIG. 4 is a partial schematic view of a vibration suppression casing according to a second embodiment;

FIG. 5 is a partial schematic view of a vibration suppression casing according to a third embodiment;

FIG. 6 is a partial schematic view of a vibration suppression casing according to a fourth embodiment; and

FIG. 7 is a partial schematic view of a vibration suppression casing according to a fifth embodiment.

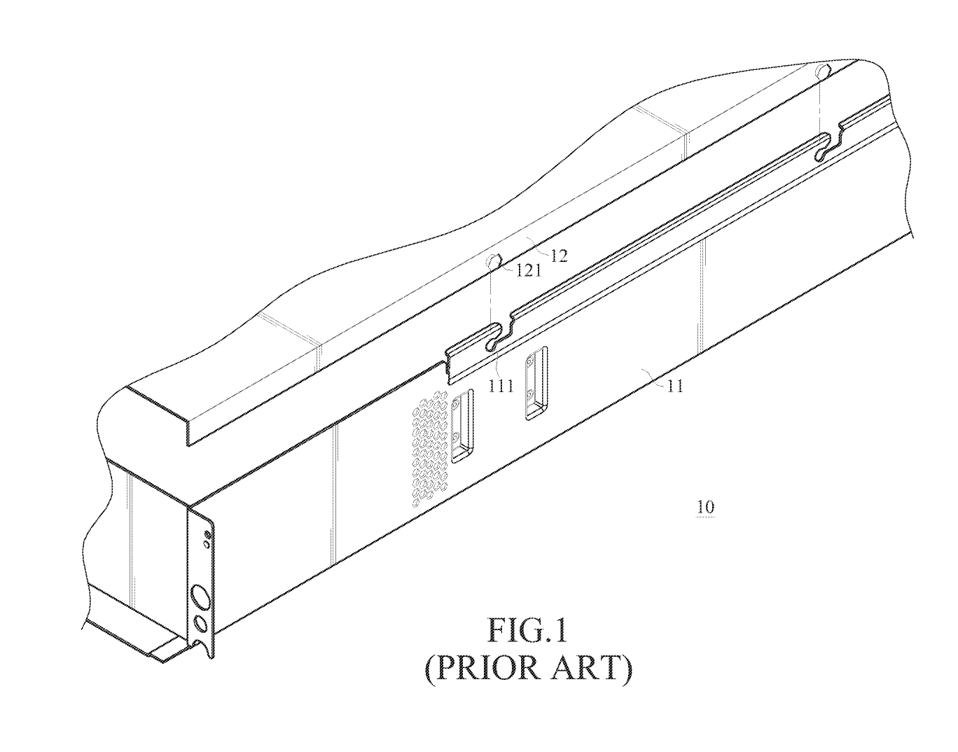

### DETAILED DESCRIPTION

The detailed features and advantages of the disclosure are described below in great detail through the following embodiments, the content of the detailed description is sufficient for those skilled in the art to understand the technical content of the present disclosure and to implement the disclosure there accordingly. Based upon the content of the specification, the claims, and the drawings, those skilled in the art can easily understand the relevant objectives and advantages of the disclosure.

A vibration suppression casing according to embodiments of this disclosure is suitable for a computing system, which has a computing function to provide users with the needed information. In this embodiment, the computing system is used as a server, but not limited to the disclosure. Furthermore, the vibration suppression casing comprises a vibration suppression unit to suppress the vibration caused by the computing system while running.

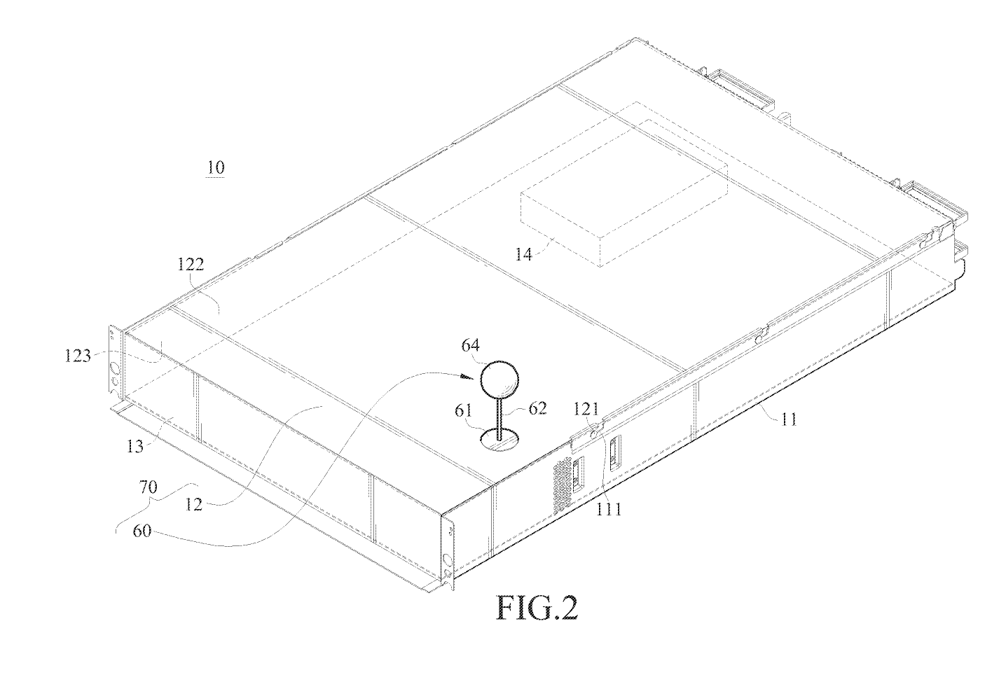

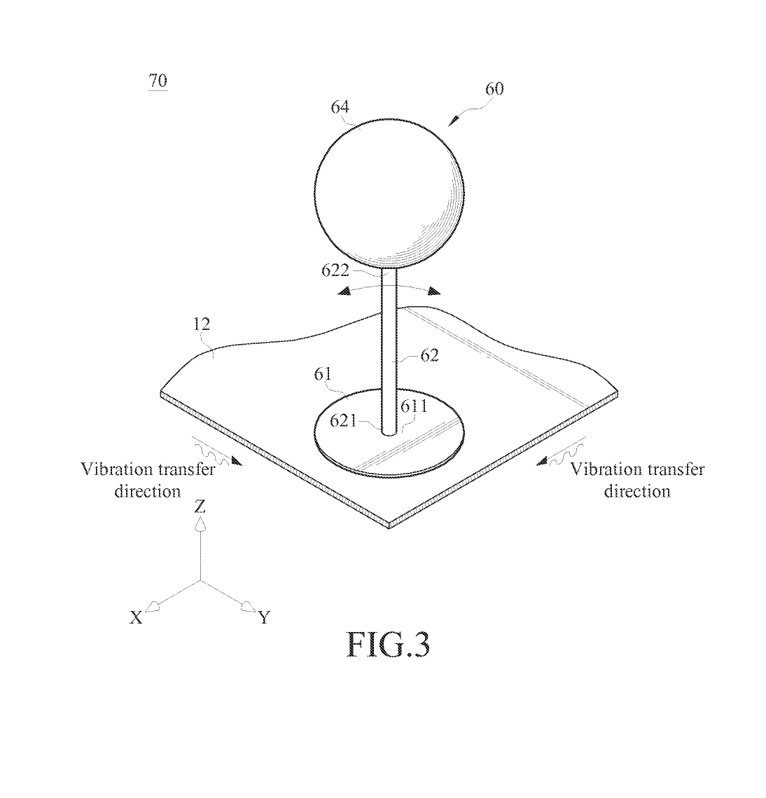

The computing system of the first embodiment is described as followed. Please refer to both FIGS. 2 and 3. FIG. 2 is a schematic view of a computing system according to a first embodiment, and FIG. 3 is a partial schematic view of a vibration suppression casing according to the first embodiment. In this embodiment, the computing system 10 comprises a chassis 11, a mainboard 13, an electronic device 14 and a vibration suppression casing 70. The vibration suppression casing 70 comprises an upper case body 12 and a vibration suppression unit 60.

The following is to describe the structure of the computing system 10. The mainboard 13 is disposed inside the chassis 11. In this embodiment, the mainboard 13 is connected to the chassis 11 by screwing. The electronic device 14, disposed inside the chassis 11, is electrically connected to the mainboard 13. In this embodiment, the electronic device 14 is a hard disk. When the electronic device 14 runs at high speed, vibration occurs and the vibration wave may transfer to the chassis 11, and then transfer to other components in contact with the chassis 11, which may lead to a synchronous vibration of the components.

The following is to describe the structure of the vibration suppression casing 70. In this embodiment, the upper case body 12 on the vibration suppression casing 70 is detachably connected to the chassis 11, and the upper case body 12 covers a surface of the chassis 11, to avoid the mainboard 13 and the electronic device from being exposed to an external environment, preventing unintended damages. Moreover, the vibration suppression unit 60 of the vibration suppression casing 70 is disposed on the upper case body 12. In addition, in this embodiment, the upper case body 12 comprises a slider 121, and the chassis 11 comprises a runner 111. The upper body 12 is attached to the chassis 11 by the slider 121 sliding into the runner 111.

Referring to FIG. 2, in this embodiment, the upper case body 12 constitutes the largest frame surface of the computing system 10, but not limited to the disclosure. In other embodiments, the case body having the largest frame surface is not the upper case body. For example, if the computing system is a tower type desktop computer, and the case body having the largest frame surface is a lateral case body which is detachably disposed on one side surface of the computing system. When the vibration suppression unit is disposed on the side case body, the vibration suppression effect may still be achieved.

Referring back to FIGS. 2 and 3, in this embodiment, the upper case body 12 has an inner surface 123 and an outer surface 122, and the inner surface 123 and the outer surface 122 are oppositely to each other. The inner surface 123 faces toward the mainboard 13.

The following is to describe the vibration suppression unit 60 of the vibration suppression casing 70. In this embodiment, the vibration suppression unit 60 comprises a base 61, an elastic arm 62 and a balancing weight 64. The base 61 is securely disposed on the outer surface 122 of the upper case body 12. In this embodiment, the base 61 is a circular plate. The elastic arm 62 has a first end 621 and a second end 622 opposite to each other, and the first end 621 is connected to a center portion 611 of the base 61. In this embodiment, the elastic arm 62 is a straight rod with elastic property, by which the elastic arm 62 may sway back and forth along with the vibration of the upper case body 12. The balancing weight 64, disposed on the second end 622, is adapted to move in conjunction with the movement of the attached base 61, driven by the vibration wave. Furthermore, the balancing weight 64 is adapted to adjust the natural frequency of the vibration suppression unit 60, making the natural frequency equal to the frequency of the vibration wave generated when the electronic device 40 vibrates, so as to absorb the vibration wave generated by the electronic device 40.

Furthermore, in this embodiment, the upper case body 12, the base 61, the elastic arm 62 and the balancing weight 64 are integrally formed into one piece, but not limited to the disclosure. In other embodiments, the vibration suppression unit 60 is welded on the upper case body 12. Additionally, in this embodiment, the vibration suppression unit 60 is made of metal, but not limited to the disclosure.

In other embodiments, the electronic device 14 is a fan, which may cause a vibration wave while running Moreover, in other embodiments, the base of the vibration suppression unit is disposed on the inner surface of the upper case body (not shown); in such an arrangement that the same effect can be achieved, too.

The vibration suppression function of the vibration suppression casing 70 will be described hereinafter, please refer to both FIGS. 2 and 3. The electronic device 14 generates a vibration wave while running, which will be transferred to the mainboard 13, the chassis 11, the upper case body 12 and the vibration suppression unit 60 in sequence. When the vibration wave is transferred to the chassis 11 and the upper case body 12, although the slider 121 is fitted tightly to the runner 111, vibration still occurs, which results in friction between them, and thereby making noise. In some embodiments, clearance is formed between the chassis 11 and the upper case body 12, due to manufacturing tolerance or repeated assembly and disassembly of them such that it is easy to cause an unintended movement of the slider 121 in the runner 111. Therefore, compared with the situation when the slider 121 is fitted tightly to the runner without the clearance, the friction caused by the vibration wave in the clearance between the chassis 11 and the upper case body 12 are more intense, thereby making a louder noise level. However, the causes leading to noise are not limited to the disclosure. In other embodiments, if the chassis and the upper case body are affixed to each other by screwing, a clearance may be formed between a screw and the screw hole on the chassis or the screw and the upper body by incomplete screwing or repeated assembly and disassembly. When the electronic device runs, friction also occurs between the chassis and the upper case body, leading to louder noise level. In order to solve the above noise problem caused by vibration, in this embodiment, the vibration suppression unit 60 is disposed on the upper case body 12. When the vibration wave is transferred to the vibration suppression unit 60 from the upper case body 12, the elastic arm 62 of the vibration suppression unit 60 and the balancing weight 64 may sway in conjunction with the base 61. In other words, when the elastic arm 62 and the balancing weight 64 sway towards in the direction of the X or the Y axis, or towards both of them simultaneously, the swaying of the vibration suppression unit 60, with a natural frequency within the vibration frequency range of the computing system, may absorb the vibration of the upper case body 12, thereby reducing the noise while vibrating. Moreover, in this embodiment, the upper case body 12 constitutes the largest frame surface of the computing system 10. Compared with each surface of the chassis 11, the largest frame surface generates the largest vibration amplitude, and therefore the vibration suppression unit 60 of this embodiment is the upper case body, arranged on the largest frame surface. When the electronic device 14 generates vibration while running, such a structure arrangement will absorb the maximum vibration of the computing system 10, so as to achieve a better arrangement of the vibration suppression unit 60.

In the first embodiment, the balancing weight is a globe body, and the elastic arm 62 is a straight rod, but not limited to the disclosure. In other embodiments, the dimensions, materials, connection and weights of the base 61, the elastic arm 62 and the balancing weight 64 of the vibration suppression unit 60 may be changed according to actual situations, so as to improve the effectiveness of vibration suppression.

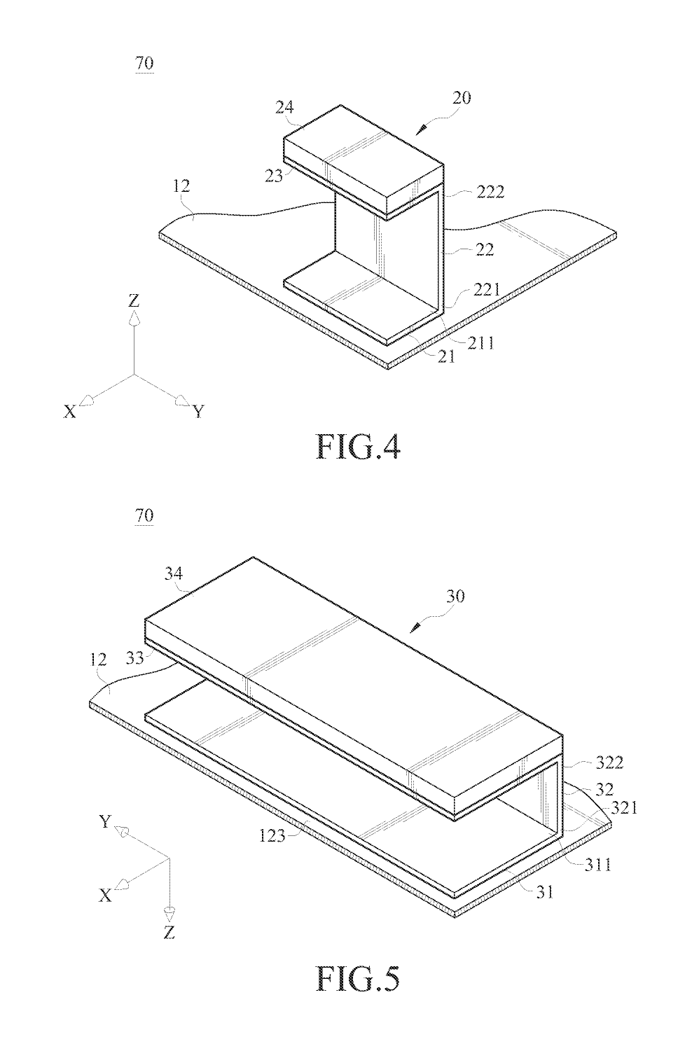

The following is to describe the vibration suppression units in other shapes. Please refer to FIG. 4, which is a partial schematic view of a vibration suppression casing according to a second embodiment. In this embodiment, a vibration suppression unit 20 of a vibration suppression casing 70 comprises a base 21, an elastic arm 22 and a balancing weight 24. In this embodiment, the base 21 is disposed on the case body 12. The elastic arm 22 has a first end 221 and a second end 222. The first end 221 is connected to an end 211 of the base 21, and the elastic arm 22 extends reversely from the upper case body 12. In addition, the elastic arm 22 has a top portion 23, which extends from the second end 222 of the elastic arm 22 towards the direction parallel to the base 21, but the parallel direction is not limited to the disclosure. The balancing weight 24, disposed on the top portion 23, has a surface contacting with the surface of the top portion 23 in the same shape. In other words, in this embodiment, the surface shape of the balancing weight 24 contacting the top portion 23 is the same as the surface of the top portion 23. In this embodiment, the overall shape of the base is the same with that of the top portion 23. In other words, in this embodiment, the base 21 is a rectangular plate, the elastic arm 22 is L-shaped, the top portion 23 is a rectangular plate, and the balancing weight 24 is also rectangular. Moreover, in this embodiment, the vibration suppression unit 20 and the upper case body 12 are integrally formed into one piece.

The following is to describe a vibration suppression unit in another shape, please refer to FIG. 5, which is a partial schematic view of a vibration suppression casing according to a third embodiment. The shape of a vibration suppression unit 30 in the third embodiment is similar to that of the vibration suppression unit 20 in the second embodiment. The vibration suppression unit 30 of a vibration suppression casing 70 comprises a base 31, an elastic arm 32 and a balancing weight 34. The elastic arm 32 has a first end 321 and a second end 322. The first end 321 is connected to an end 311 of the base 31. The elastic arm has a top portion 33 located at the second end 322. The balancing weight 34 is disposed on the top portion 33 of the second end 322. Compared with the second embodiment, in the vibration suppression unit 30 of this embodiment, the superficial areas of the base 31 and the balancing weight 34 facing towards the upper case body 12 are both greater than the superficial area of the elastic arm facing towards the X axis. Therefore, compared with absorbing the vibration wave transferred along the directions of the Z axis and the Y axis, the vibration suppression unit 30 of this embodiment can absorb a more intense vibration wave from the direction of the Z axis. In this embodiment, the vibration suppression unit 30 is disposed on the inner surface 123 of the upper case body 12. Additionally, in this embodiment, the vibration suppression unit 30 is welded on the upper case body 12, but not limited to the disclosure.

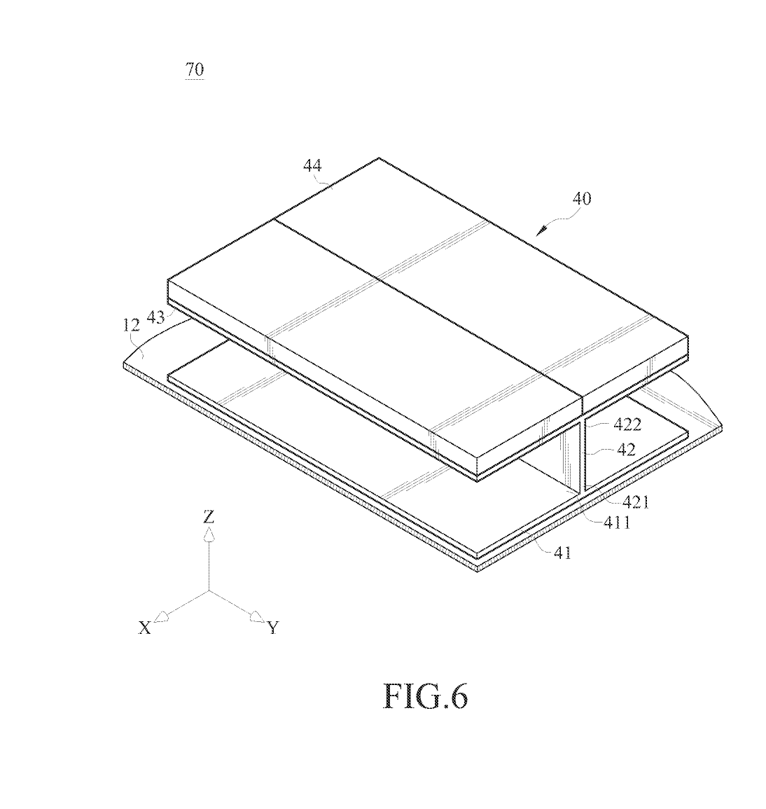

Please refer to FIG. 6, which is a partial schematic view of a vibration suppression casing according to a fourth embodiment. In this embodiment, a vibration suppression unit 40 of a vibration suppression casing 70 comprises a base 41, an elastic arm 42 and a balancing weight 44. The elastic arm 42 has a first end 421 and a second end 422. The first end 421 is disposed on and stretches across the center portion 411 of the base 41. The elastic arm 42 has a top portion 43, located at the second end 422 and extending towards the direction of the X axis from the second end 422. In other words, the shape of the top portion 43 is the same as that of the base. Furthermore, the balancing weight 44, disposed on the top portion 43 of the elastic arm 42, has a surface contacting with the surface of the top portion 43 in the same shape. In this embodiment, the vibration suppression unit 40 may suppress the vibration wave transferred by the upper case body 12, when the electronic device (not shown) runs, by the swaying of the balancing weight 44 relative to the base 41 which is connected to the upper case body 12. In this embodiment, the base 41 is a rectangular plate, the elastic arm is T-shaped, the top portion 43 is a rectangular plate, and the balancing weight 44 is rectangular. The shape of base 41 corresponds to that of the top portion 43. The surface shape of the balancing weight 44 contacting with the top portion 43 corresponds to the surface of the top portion 43. In this embodiment, the vibration suppression unit 40 is securely affixed to the upper case body 12, but not limited the disclosure.

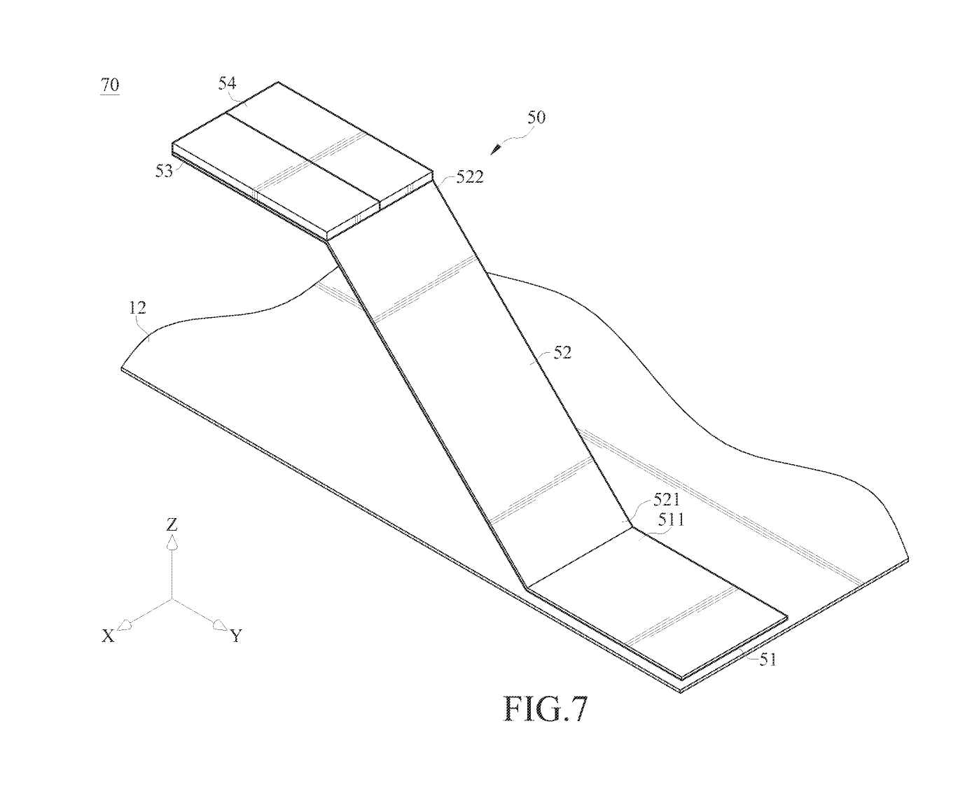

In other embodiments, the elastic arm of the vibration suppression unit is not perpendicular to the case body. Please refer to FIG. 7, which is a partial schematic view of a vibration suppression casing according to a fifth embodiment. In this embodiment, a vibration suppression unit 50 comprises a base 51, an elastic arm 52 and a balancing weight 54. The base 51 is disposed on the upper case body 12. The elastic arm 52 has a first end 521 and a second end 522. The first end 521 is connected to an end 511 of the base 51. The elastic arm 52, which extends upwards at a tilt angle (not perpendicular to the direction of the Z axis) from the end 511 end 511 of the base 51, has a top portion 53, located at the second end 522. The balancing weight 54 is arranged on the top portion 53. In this embodiment, the vibration suppression unit 50 is suitable for suppressing the vibration wave in the directions of the Y axis and the Z axis.

According to the vibration suppression casing disclosed in the disclosure, the vibration suppression unit is disposed on the case body by way of adhering, welding or screwing. Besides, the vibration suppression unit and the case body are integrally formed into one piece.

According to the vibration suppression casing disclosed in the disclosure, the dimensions, material, connection and the weight of the vibration suppression unit may be adjusted based on actual situations, to improve the effect of vibration suppression. In addition, when the natural frequency of the vibration suppression unit is located within the vibration frequency range of the computing system, the vibration suppression effect of the vibration suppression unit may be enhanced. In one embodiment, the natural frequency of the vibration suppression unit is equal to the vibration frequency of the computing system.

In conclusion, the vibration suppression casing disclosed in the disclosure comprises the vibration suppression unit and the case body. The vibration suppression unit is disposed on the case body. When the electronic device runs, and then the vibration wave transfers to the vibration suppression unit, the balancing weight moves relative to the base to absorb the vibration of the overall computing system, while achieving the effect of reducing noise, so as to prevent user from discomfort. Moreover, when the vibration suppression casing absorbs vibration, the computing system may run more stable. Furthermore, the dimensions, material, connection and the weight of the vibration suppression unit can be adjusted, making the natural frequency of the vibration suppression unit equal to the frequency of the vibration wave, thereby improving the effect of the vibration suppression unit in suppressing the vibration of the case body.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A vibration suppression casing, suitable for a computing system including a chassis, a mainboard, and an electronic device; wherein the mainboard is disposed in the chassis; the electronic device is disposed in the chassis, the computing system is adapted to generate a vibration wave while running; the vibration suppression casing comprises:
a case body detachably attached to the chassis; and
a vibration suppression unit disposed on the case body, wherein the vibration suppression unit comprises:
a base securely disposed on the case body;
an elastic arm having a first end and a second end, opposite to each other, the first end being connected to the base; and
a balancing weight disposed on the second end, wherein the balancing weight moves in conjunction with the movement of the attached base, driven by the vibration wave.

2. The vibration suppression casing according to claim 1, wherein the vibration suppression unit is integrally formed into one piece.

3. The vibration suppression casing according to claim 1, wherein the case body has an inner surface and an outer surface, the inner surface and the outer surface are opposite to each other, the inner surface faces towards the mainboard, and the base is disposed on the outer surface.

4. The vibration suppression casing according to claim 1, wherein the case body has an inner surface and an outer surface, the inner surface and the outer surface are opposite to each other, the inner surface faces towards the mainboard, and the base is disposed on the inner surface.

5. The vibration suppression casing according to claim 1, wherein the vibration suppression unit and the case body are integrally formed into one piece.

6. The vibration suppression casing according to claim 1, wherein the case body constitutes the largest frame surface of the computing system.

7. The vibration suppression casing according to claim 1, wherein the case body includes a slider, the chassis includes a runner, and the case body is attached to the chassis by the slider sliding into the runner.

8. The vibration suppression casing according to claim 1, wherein the balancing weight is adapted to adjust the natural frequency of the vibration suppression unit, making the natural frequency equal to the frequency of the vibration wave.
